(19) United States
(12) Patent Application Publication
(10) Pub. No.: US 2025/0377038 A1
(43) Pub. Date: Dec. 11, 2025

(54) ELASTIC SLIDING BEARING OF SHIFT ELEMENT

(71) Applicant: ZF Friedrichshafen AG, Friedrichshafen (DE)

(72) Inventors: Marcel Störkle, Bad Saulgau (DE); Bernd Lutz, Uhldingen-Mühlhofen (DE); Maximilian Scheufler, Salem (DE); Stefan Renner, Bodman-Ludwigshafen (DE); Andreas Graf, Stockach (DE); Martin Weiss, Markdorf (DE); Rayk Gersten, Friedrichshafen (DE)

(73) Assignee: ZF Friedrichshafen AG, Friedrichshafen (DE)

(21) Appl. No.: 19/230,384

(22) Filed: Jun. 6, 2025

(30) Foreign Application Priority Data
Jun. 7, 2024 (DE) 10 2024 205 278.7

(51) Int. Cl. F16H 63/32

(52) U.S. Cl. CPC F16H 63/32; F16H 2063/321

(57) ABSTRACT

A device (12) for mounting a shift element (14) on a transmission shaft (16), has a first unit (18) having a sliding region for enabling axial and/or radial relative movement between the transmission shaft (16) and the shift element (14). The device has a second unit (20) having a compression region for counteracting radial deflection of the shift element (14) when the shift element (14) is subjected to a torque load. The present invention also relates to a corresponding shift element and system.

### RELATED APPLICATIONS

This application claims the benefit of and right of priority under 35 U.S.C. § 119 to German Patent Application no. 10 2024 205 278.7, filed on 7 Jun. 2024, the contents of which are incorporated herein by reference in its entirety.

### FIELD OF THE DISCLOSURE

The present invention relates to a device for mounting a shift element on a transmission shaft. The present invention also relates to a corresponding shift element and a system.

### BACKGROUND

Shift elements or shift sleeves are used in a wide range of automotive transmissions. in transmissions of this type. all gear wheels that determine the gear selection are in constant mesh, wherein a connection with an actuating effect between an idler wheel mounted on a transmission shaft and the transmission shaft can be established by shifting the shift element. The shift elements must therefore be mounted in such a way that axial movement is possible. In addition, the shift elements must transmit high forces between the idler wheel and the transmission shaft

Shift elements are often mounted between the idler wheel, which can connect them to the transmission shaft with an actuating effect, and the transmission shaft. in some cases, two different bearing locations are used, the centers of which are offset so that a high torque can act on a free end of the shift element during shifting and operation of the transmission. High radial loads in particular can lead to increased wear on the shift element.

The disclosure document DE 10 2005 048 527 A1 describes a bearing for a gear wheel arrangement with a housing having at least one plain bearing receiving space, wherein at least one plain bearing is received in the plain bearing receiving space. A shaft is mounted in at least one such plain bearing, wherein the elastic elements is inserted between the plain bearing and the plain bearing receiving space.

### SUMMARY

Based on this, the present invention aims to provide an improved approach for mounting a shift element in a transmission. In particular, an effective means of mounting, guiding, and preventing radial deflection of a shift element is to be provided. which is preferably cost-efficient to manufacture.

This task is solved by a device for mounting a shift element on a transmission shaft having a first unit, which can be arranged on the shift element and has a sliding region for enabling axial and/or radial relative movement between the transmission shaft and the shift element; and a second unit, having a compression region to counteract radial deflection of the shift element when the shift element is subjected to a torque load.

The above task is further solved by a shift element having. a first bearing, a second bearing; and a device as previously defined, wherein the first bearing is arranged at a first end of the shift element, the second bearing is arranged axially and/or radially offset relative to the first bearing in a region of the first end of the shift element, and the device is arranged at an end of the shift element opposite to the first end.

The above task is ultimately solved by a system with an idler wheel; a shift element as defined above, and a transmission shaft; wherein
the shift element is mounted on the idler wheel by means of the first bearing;
the idler wheel is mounted on the transmission shaft by means of the second bearing;
preferably, the shift element can be mounted on the transmission shaft by means of the second bearing; and
the shift element is mounted on the transmission shaft by means of the device.

Preferred embodiments of the invention are described in the dependent claims. It is understood that the features mentioned above and those to be explained below can be used not only in the combination specified in each case, but also in other combinations or alone, without leaving the scope of the present invention. In particular.

the system may be implemented in accordance with the embodiments described in the dependent claims.

A device comprising a first unit and a second unit allows each of the two units to be individually adapted to its requirements. For example, the first unit may have improved axial and/or radial sliding properties and preferably be made of a different material than the second unit, which is particularly preferably designed to be elastically deformable.

in particular, the device allows guidance with minimal clearance or slight overlap when the shift element is unloaded. in addition, the elastic compression region enables a reduction in radial load, preferably through elastic deformation of the second unit when torque is applied.

The advantageous embodiment of the device allows centering and guidance of the shift element even when no load is applied. n addition, even with radial deflection, the shift element can be guided, tolerances can be compensated under load, and coaxiality can compensated during rotary motion.

The elastic deformation of the second unit preferably allows the radial force on the shift element to be minimized, wherein the first unit enables axial movement of the shift element to change the shifting position.

In a preferred embodiment, the first unit comprises a plain bearing and the second unit comprises an elastic element. In particular, the device can be constructed in two parts. By using a plain bearing in combination with an elastic element, an existing plain bearing can be supplemented with an elastic element, thereby creating an advantageous device for mounting the shift element in a cost-efficient and technically simple manner. In particular, he advantageous arrangement of the device at an end of the shift element opposite the point of arrangement of the idler wheel allows improved bearing support where high torque loads act on the shift element.

The plain bearing preferably has a flat or convex contact surface for contact with the shift element for enabling axial and/or radial movement between a transmission shaft on which the shift element is mounted and the shift element. A flat or convex contact surface allows for optimal positioning of the plain bearing and improved sliding properties Furthermore, tilting and/or jamming of the plain bearing can be efficiently counteracted.

The elastic element preferably has a first contact region for contact with the plain bearing and a second contact region for contact with the transmission shaft. In other words, the elastic element is arranged radially within the plain bearing and preferably surrounds a transmission shaft This advantageous arrangement allows the plain bearing to be fixed to the transmission shaft so that the shift element slides over the plain bearing. In this case, a plain bearing and guide can be provided on the element that performs both a sliding movement and a relative rotational movement relative to the transmission shaft during operation.

In a preferred embodiment, the elastic element is made of an elastomer and the plain bearing is made of PEEK. This advantageous combination of materials makes it possible to create a cost-effective and lightweight plain bearing that can be easily combined with an elastic element. In particular, it is conceivable to design the elastic element as an elastomer ring, wherein he plain bearing rests radially outside on the elastomer ring. In a particularly preferred embodiment, a receptable for the elastomer can be formed radially within the plain bearing so that slippage between the elastic element and the plain bearing can be counteracted.

It is understood that the PEEK of the plain bearing may contain fillers to improve the sliding properties of the plain bearing.

In a preferred embodiment, the first unit and the second unit are manufactured in one piece, wherein the second unit is spring-loaded. This allows the production process for the device to be optimized, as it can preferably be manufactured as a single injection-molded part, particularly preferably from PEEK. The spring-loaded design can be achieved, for example, by tapering the material or by using a suitable geometry, such as a spring nose or one or more spring-like webs.

The elastic element is preferably rotationally symmetrical and can be arranged around the transmission shaft. The spring-loaded element preferably has a circular cross-section and is designed, for example, as an elastomer O-ring. This allows the spring-loaded element to be produced in large quantities in a technically simple and cost-efficient manner.

The plain bearing is preferably rotationally symmetrical and arranged radially outside the elastic element. It preferably has a rectangular cross-section. A rectangular cross-section allows a sliding surface to be formed on the plain bearing, which prevents the plain bearing from filling. The relatively simple cross-sectional geometry makes the plain bearing technically simple and cost-efficient manufacture.

PEEK, polyetheretherketone, is a high-temperature-resistant, semi-crystalline thermoplastic material that belongs to the polyaryletherketone group of materials.

An elastomer is a plastic that retains its shape but is elastically deformable. The glass transition point of an elastomer is below the operating temperature. During use, an elastomer can deform elastically under tensile and/or compressive load. After a force is applied, the elastomer returns to its original, undeformed shape. Examples of elastomers include vulcanized natural rubber and silicone rubber

Plain bearings are machine elements that serve to reduce friction between two surfaces moving against each other and/or to guide machine elements. They often support and guide a shaft that rotates and/or moves relative to the bearing housing. Plain bearings minimize friction between two machine elements.

A transmission shaft is a rotating elongated machine element on which an idler wheel is mounted so that it can rotate. To transfer rotational movements and torques from the idler wheel to the transmission shaft, the idler wheel can be engaged with an actuating effect by inserting a shift element. Here, the idler wheel is preferably connected to the transmission shaft by means of a positive connection using the shift element. When engaged, the idler wheel acts like a fixed wheel, i.e., a gear wheel that is firmly connected to the transmission shaft.

### BRIEF DESCRIPTION OF THE DRAWINGS

The invention is described and explained in more detail below with reference to a few selected exemplary embodiments in conjunction with the accompanying drawings. The following are shown:

FIG. 1: Schematically simplified representation of a system,

FIG. 2: is a more detailed schematic representation of the system according to FIG. 1;

FIG. 3: is a schematic representation of a section of the system according to FIGS. 1 and 2; and

FIGS. 4a and 4b: schematically show different geometries of a one-piece device.

### DETAILED DESCRIPTION

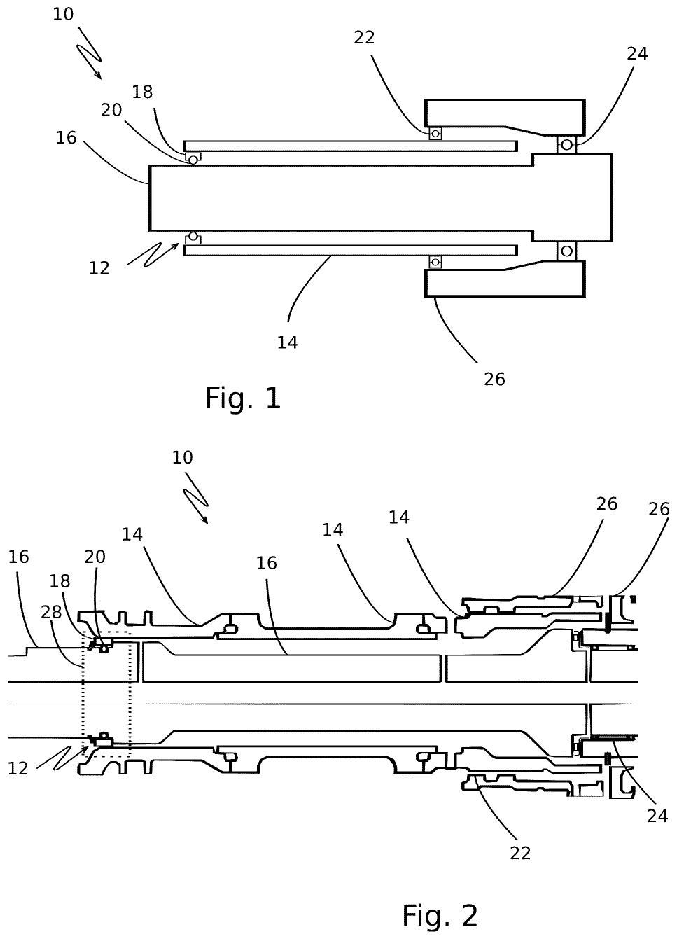

FIG. 1 shows a simplified diagram of a system 10. The system 10 comprises a device 12 for mounting a shift element 14 on a transmission shaft 16.

The device 12 comprises a first unit 18, which in the example shown is designed as a plain bearing and is arranged radially within the shift element 14 and rests against an inner surface of the shift element 14.

The device 12 further comprises a second unit 20, which is designed in the form of an elastic O-ring with a circular cross-section and is arranged radially inside the first unit 18.

The second unit 20 is connected to the transmission shaft 16.

The system 10 further has a first bearing 22 and a second bearing 24, wherein the first bearing 22 is arranged between the shift element 14 and a schematically represented idler wheel 26.

The second bearing 24 is arranged between the transmission shaft 16 and the idler wheel 26.

The device 12 is arranged at a first end of the shift element 14. The first bearing 22 and the second bearing 24 are arranged in a region of a second end of the shift element 14, wherein the second end is opposite the first end in the axial direction.

FIG. 2 shows a system 10 similar to FIG. 1 in greater detail. Identical reference symbols refer to identical features and are not explained again.

In the example shown, the first bearing 22 is formed by corresponding contact regions on the idler wheel 26.

The second bearing 24 is located in the vicinity of an interlocking gearing which is connected with an actuating effect to the shift element 14 and the idler wheel 26.

By moving the shift element 14 to the left, the shift element 14 can be brought into engagement with a gearing of the transmission shaft 16. This establishes a connection with an actuating effect between transmission shaft 16 and idler wheel 26.

In this shifting position, the shift element 14 is also mounted on the second bearing 24.

FIG. 2 also shows a region 28 marked with a dashed line in which the device 12 is arranged.

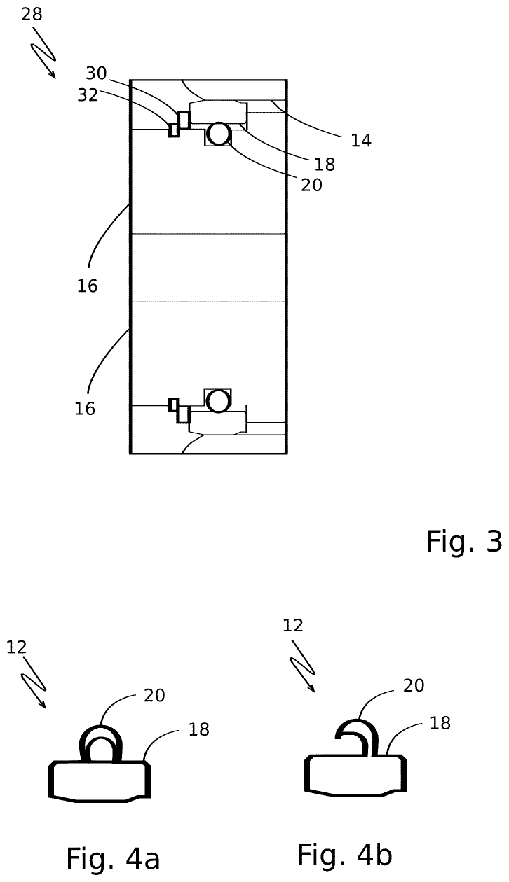

This region 28 is shown in detail and enlarged in FIG. 3.

In the embodiment shown, the device 12 is also formed by a first unit 18 in the form of a plain bearing and a second unit 20 in the form of an elastic element.

The elastic element is arranged in a recess extending in a circumferential direction of the transmission shaft 16 in order to fix the elastic element with respect to its axial position.

The plain bearing is arranged radially within the shift element 14 and rests with a first side on the shift element 14 and with a second side opposite the first side on the elastic element.

The plain bearing is located in an axial direction on the transmission shaft 16, which has a corresponding radial extension for this purpose.

On the opposite side, the plain bearing is secured against axial displacement by an additional element 30, wherein the additional element 30 is also secured against axial displacement by means of a securing element 32.

The securing element 32 is accommodated for this purpose in a recess formed in the transmission shaft 16 in the direction of rotation.

FIGS. 4a and 4b schematically show different embodiments of the device 12. Unlike the previous embodiments. the device 12 according to FIGS. 4a and 4b is designed as a single piece, with the second unit 20 being elastically spring-loaded by means of a corresponding geometry.

In FIG. 4a, elastic spring action of the second unit 20 is achieved by the second unit 20 having a semicircular cross-section that encloses a cavity so that the second unit 20 can spring back elastically when subjected to radial forces.

This geometry allows the second unit 20 to be pressed in, thereby moving back radially and exerting a high counterforce. Furthermore, providing a cavity allows a compromise to be achieved between elastic deformation and mechanical stability.

FIG. 4b shows an embodiment in which the second unit 20 is designed as a kind of spring nose, wherein the second unit 20 can spring back elastically thanks to the appropriate dimensioning of the material.

By designing the second unit 20 as one or more spring lugs, an elastic restoring force can be easily provided as required. In addition, the injection molding manufacturing method is simplified.

The invention has been comprehensively described and explained on the basis of the drawings and the description. The description and explanation are examples and are not intended to be restrictive. The invention is not limited to the disclosed embodiments. Other embodiments or variations will be apparent to those skilled in the art upon use of the present invention and upon careful analysis of the drawings, the disclosure, and the appended claims.

In the patent claims, the words “comprising” and “having” do not exclude the presence of further elements or steps. The indefinite article “a” does not exclude the existence of a plural. A single element or unit may perform the functions of several of the units mentioned in the patent claims. An element, unit, interface, device, and system may be implemented in whole or in part in hardware and/or software. The mere mention of certain measures in several different dependent patent claims is not to be understood as meaning that a combination of these measures cannot also be used advantageously. References in the patent claims are not to be understood as limiting.

### REFERENCE NUMBERS

10 system
12 device
14 shift element
16 transmission shaft
18 first unit
20 second unit
22 first bearing
24 second bearing
26 idler wheel
28 region
30 additional element
32 securing element

1. A device (12) for mounting a shift element (14) on a transmission shaft (16), the device comprising:
a first unit (18) having a sliding region configured for enabling axial and/or radial relative movement between the transmission shaft (16) and the shift element (14); and
a second unit (20) having a compression region for counteracting radial deflection of the shift element (14) when the shift element (14) is subjected to a torque load.

2. The device (12) according to claim 1, wherein the first unit (18) has a plain bearing, and the second unit (20) has an elastic element.

3. The device (12) according to claim 1, wherein the plain bearing has a flat or convex contact surface for contact with the shift element (14) for enabling a axial and/or radial movement between a transmission shaft (16), on which the shift element (14) is mounted, and the shift element (14).

4. The device (12) according to claim 1, wherein the elastic element has a first contact region for contact with the plain bearing and a second contact region for contact with the transmission shaft (16).

5. The device (12) according to claim 1, wherein the elastic element is made of an elastomer, and the plain bearing is made of PEEK.

6. The device (12) according to claim 1, wherein the first unit (18) and the second unit (20) are manufactured in one piece and the second unit (20) is spring-loaded.

7. The device (12) according to claim 1, wherein the elastic element is rotationally symmetrical, can be arranged around the transmission shaft (16), and has a circular cross-section

8. The device (12) according to claim 1, wherein the plain bearing is rotationally symmetrical, is arranged radially outside the elastic element and has a rectangular cross-section.

9. A shift element (14) comprising:
a first bearing (22);
a second bearing (24); and
the device (12) according to claim 1; wherein
the first bearing (22) is arranged at a first end of the shift element (14),
the second bearing (24) is arranged axially and/or radially offset relative to the first bearing (22) in a region of the first end of the shift element (14), and
the device (12) is arranged at an end of the shift element (14) opposite the first end.

10. A system (10) comprising:
an idler wheel (26);
a shift element (14) comprising:
a first bearing (22);
a second bearing (24); and
the device (12) according to claim 1; wherein
the first bearing arranged at a first end of the shift element (14);
the second bearing (24) is arranged axially and/or radially offset relative to the first bearing (22) in a region of the first end of the shift element (14); and
the device (12) is arranged at an end of the shift element (14) opposite the first end; and
a transmission shaft (16), wherein the shift element (14) is mounted on the idler wheel (26) by means of the first bearing (22);
the idler wheel (26) is mounted on the transmission shaft (16) by means of the second bearing (24),
the shift element (14) is configured to be mounted on the transmission shaft (16) by means of the second bearing (24); and
the shift element (14) is mounted on the transmission shaft (16) by means of the device (12).
